(19) United States
(12) Patent Application Publication
(10) Pub. No.: US 2014/0081588 A1
(43) Pub. Date: Mar. 20, 2014

(54) POSITIONING METHOD AND ELECTRONIC DEVICE UTILIZING THE SAME

(71) Applicant: QUANTA COMPUTER INC., Kue Shan Hsiang (TW)

(72) Inventors: Kai-Wen Tien, Kuei Shan Hsiang (TW); Jie-Min Chen, Kuei Shan Hsiang (TW); Chin-Lien Hsu, Kuei Shan Hsiang (TW); Tsung-Ying Hsieh, Kuei Shan Hsiang (TW)

(73) Assignee: QUANTA COMPUTER INC., Kuei Shan Hsiang (TW)

(21) Appl. No.: 13/712,068

(22) Filed: Dec. 12, 2012

(30) Foreign Application Priority Data
Sep. 17, 2012 (TW) 101133929

(51) Int. Cl. G01C 25/00; G06F 15/00

(52) U.S. Cl. CPC G01C 25/00; G06F 15/00
USPC 702/94

(57) ABSTRACT

A positioning method and an electronic device utilizing the same are disclosed. The positioning method, adopted by an electronic device for positioning a mobile device, includes: determining a preliminary plane location of the mobile device; obtaining a tilt angle of the mobile device; and correcting an error in the preliminary plane location based on the tilt angle, to obtain the correct plane location of the mobile device.

### CROSS REFERENCE TO RELATED APPLICATIONS

This application claims priority of Taiwan Patent Application No. 101133929, filed on 17 Sep. 2012, and the entirety of which is incorporated by reference herein.

### BACKGROUND OF THE INVENTION

1. Field of the Invention

The present invention relates to a wireless input system, and in particular to a positioning method and an electronic device utilizing the same.

2. Description of the Related Art

As wireless network technology advances, intuitive input interfaces that input system commands using a wireless device by means of various gestures in the air interface have been used in daily life. In order to interpret such gestures in a more precise manner, a positioning procedure with increased precision for wireless devices is needed.

### BRIEF SUMMARY OF THE INVENTION

In one aspect of the invention, a positioning method is disclosed, adopted by an electronic device for positioning a mobile device, comprising: determining a preliminary plane location of the mobile device; obtaining a tilt angle of the mobile device; and correcting an error in the preliminary plane location based on the tilt angle to obtain the correct plane location of the mobile device.

In yet another aspect of the invention, an electronic device is described, comprising a transceiver and a controller. The transceiver is configured to receive a first signal of a mobile device. The controller, coupled to the transceiver, is configured to determine a preliminary plane location of the mobile device according to the received first signal, obtain a tilt angle of the mobile device, and correct an error in the preliminary plane location based on the tilt angle to obtain the correct plane location of the mobile device.

### BRIEF DESCRIPTION OF DRAWINGS

The invention can be more fully understood by reading the subsequent detailed description and examples with references made to the accompanying drawings, wherein:

FIG. 1 is a system diagram of a positioning system 1 according to an embodiment of the invention;

FIG. 2 is a block diagram of the positioning device 10 according to an embodiment of the invention;

FIG. 3 depicts the hardware configuration and operation for the mobile device 12 according to an embodiment of the invention;

FIG. 4 is a block diagram of the reference devices 14 or 16 according to an embodiment of the invention;

FIG. 5 is a flowchart of the 3D positioning method 5 according to an embodiment of the invention;

FIG. 6 illustrates the plane positioning error in the positioning method according to an embodiment of the invention;

FIG. 7 shows a 3D positioning procedure according to an embodiment of the invention;

FIG. 8 depicts the controller 200 determines the tilt angle θ of the mobile device 12 by analyzing the detected image data; and

FIG. 9 shows the controller 200 determines the tilt angle θ of the mobile device 12 by processing the reception times for the two response signals.

### DETAILED DESCRIPTION OF THE INVENTION

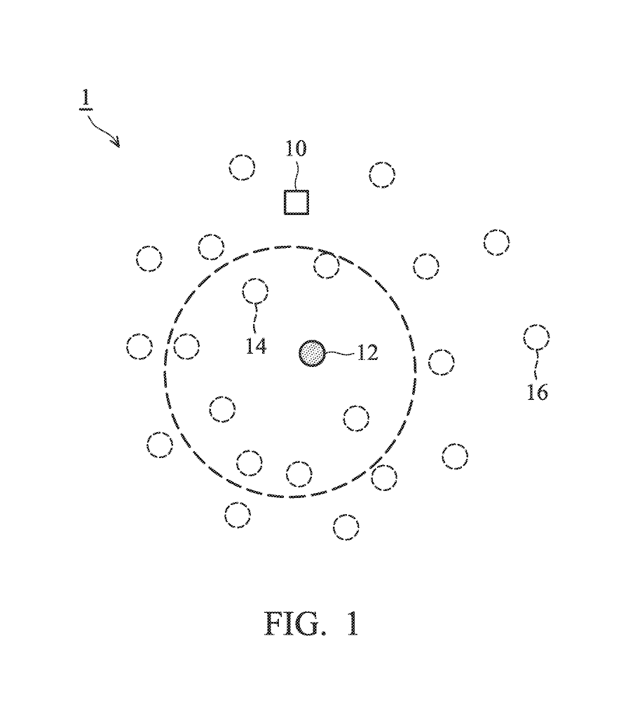

FIG. 1 is a system diagram of a positioning system 1 according to an embodiment of the invention, comprising a positioning device 10, a mobile device 12, a first reference device 14 and a second reference device 16. The positioning system 1 may be a wireless network system including a wireless local area network (WLAN) or wireless metropolitan area network (WMAN), positioning a mobile device within the network coverage by an access point (AP) which provides wireless internet access. The positioning device 10, the mobile device 12, the first reference device 14 and the second reference device 16 can communicate with one another using a common communication protocol. The mobile device 12 is a handheld input device, capable of moving in a predetermined spatial range. A user may input data or commands into the positioning device 10 by waving the mobile device 12 in the predetermined spatial range. The positioning device 10 can locate the mobile device 12 to determine the spatial position of the mobile device 12 with reference to the position of the positioning device 10, thereby determining the content in the input from the mobile device 12. In some embodiments, the mobile device 12 may be a remote control for a TV. When the user enters an input by writing a channel number in the predetermined spatial range with the mobile device 12 (i.e. drawing or waving the mobile device 12), e.g., 3, the positioning device 10 can determine that the user would like to switch the TV to channel 3 by tracing the motion of the mobile device 12 in the predetermined spatial range, and control a display device to switch the TV to channel 3 accordingly. When the user enters another input by waving the mobile device 12 upwards in the predetermined spatial range, the positioning device 10 can determine that the user would like to increase the volume by positioning and tracing the trace of the mobile device 12. As such, when the positioning device 10 can accurately locate the position of the mobile device 12 in the spatial range, the input data from the user can be determined correctly, thereupon performing the corresponding application service accordingly.

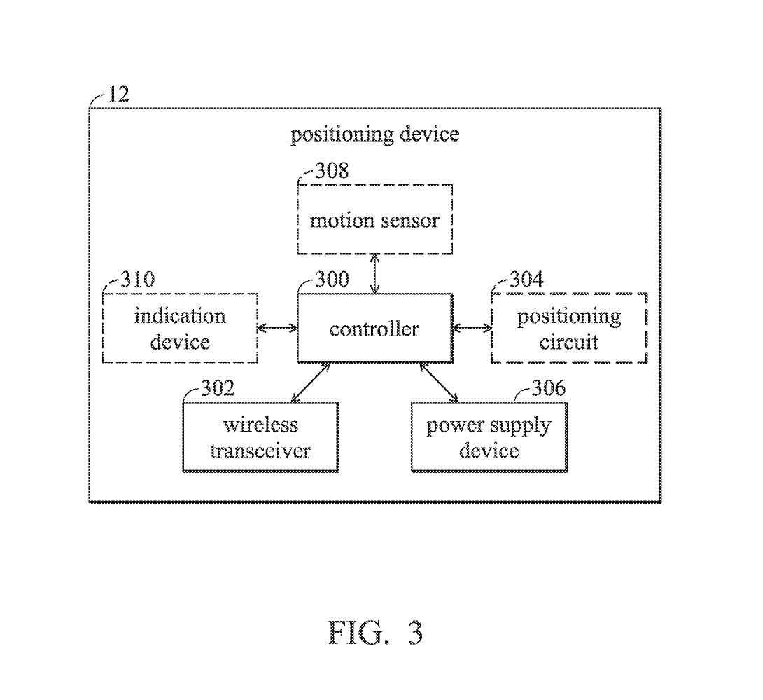

The mobile device 12 may be an electronic pan, a remote control, an entertainment device, a communication device, a home entertaining device or other mobile electronic device that is capable of communicating with the positioning device 10. The located position detected by the positioning device 10 is the position from which the mobile device 12 transmits and receives wireless signals, i.e. the setup location of the wireless transceiver module of the mobile device 12. Nevertheless, what is required to be detected may be another position on the mobile device 12, for example, the tip or front end of the mobile device 12, and not the position of the wireless transceiver module. Therefore, when the mobile device 12 is tilted, a tilt angle is formed with respect to the horizontal plane, resulting in a positioning error due to the tip or front end not being on the vertical projection of the wireless transceiver module on the mobile device 12. As a consequence, the positioning device 10 has to remove or reduce the positioning error to correct the positioning location as detected, in order to arrive at the precise location of the position of the mobile device 12. FIG. 3 depicts a hardware configuration and operation for the mobile device 12 according to an embodiment of the invention.

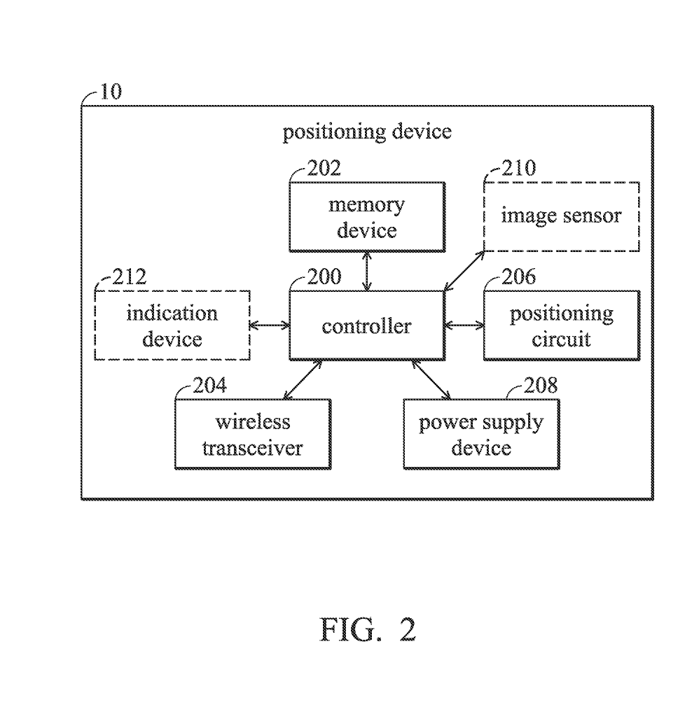

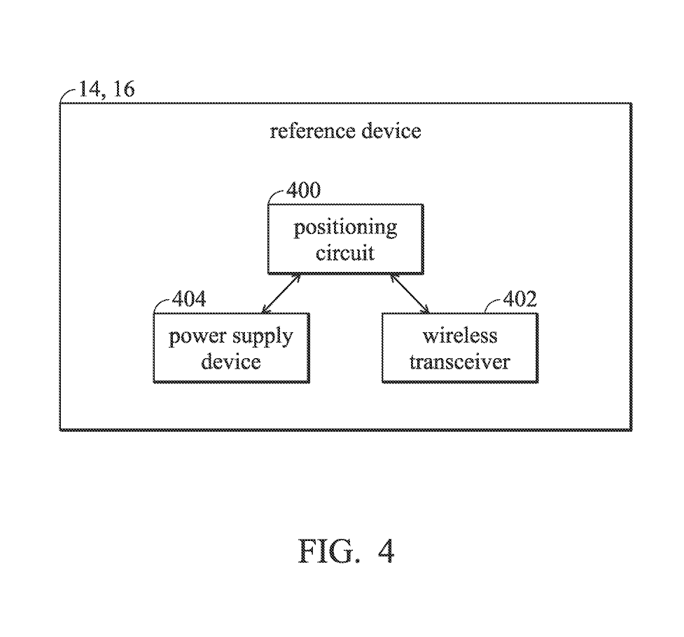

The positioning device 10 may be a set-top box, a home entertainment center server, an access point, or an interface platform with a positioning function. The positioning device 10 may utilize various positioning techniques to derive the preliminary plane location. The positioning techniques may be a Time of Arrival (referred to as TOA hereinafter) technique, a Angle of Arrival (referred to as AOA hereinafter) technique, a Received Signal Strength (referred to as RSS hereinafter) technique or another indoor positioning technique. Furthermore, the positioning device 10 can detect the tilt angle of the mobile device 12, and correct the preliminary location according to the tilt angle of the mobile device 12 to obtain the correct plane location. The positioning device 10 can further locate the location of the mobile device 12 in terms of a 3D space, based on two or more neighboring reference devices 14 and 16. The first reference device 14 and the second reference device 16 are required to be placed at different vertical locations for the positioning device 10 to determine an accurate vertical location for the mobile device 12. The hardware configurations and operations of the positioning device 10 and the reference devices 14 and 16 are detailed in FIG. 2 and FIG. 4 respectively and the corresponding paragraphs.

The embodiment provides a positioning lookup table for the mobile device, utilizing a simple yet power-saving positioning system to estimate the location of the mobile device and correct for any errors in the location estimation, thereby correcting the positioning error in terms of a plane location estimation, leading to an accurate positioning procedure within a 3D space.

FIG. 2 is a block diagram of the positioning device 10 according to an embodiment of the invention, including a controller 200, a memory device 202, a wireless transceiver 204, a positioning circuit 206, a power-supply device 208, an image sensor 210, and an indication device 212. The controller 200 is coupled to the memory device 202, the wireless transceiver 204, the positioning circuit 206, the power-supply device 208, the image sensor 210, and the indication device 212. The image sensor 210 and the indication device 212 are optional devices. In some embodiments, the positioning device 10 does not include the image sensor 210 or the indication device 212.

The wireless transceiver 204 can utilize a wireless communication technique such as an infrared technique, an ultrasonic technique, or a wireless communication technique to communicate and exchange information with the mobile device 12, the first reference device 14, and the second reference device 16. The positioning circuit 206 is configured to utilize a relevant positioning technique such as the TOA, AOA, or RSS technique to locate the preliminary plane location for the mobile device 12. In some embodiments, the positioning circuit 206 is configured to use the TOA technique to detect the preliminary plane location of the mobile device 12. The wireless transceiver 204 may broadcast a wireless signal to the air interface, causing a reflection as the wireless signal meets the mobile device 12. In turn, the wireless transceiver 204 may detect the reflected wireless signal and determine the propagation time from broadcasting to receiving the wireless signal. The positioning circuit 206 can estimate the preliminary plane location (X, Y) of the mobile device 12 from the propagation time of the wireless signal and the estimated light speed.

The controller 200 is configured to implement the error-correction method and the 3D spatial positioning method according to an embodiment of the invention. The controller 200 may allocate a memory space in memory device 202 for storing an error-correction lookup table (LUT) such as table 1, including the preliminary plane location column (X, Y), the tilt angle column θ, the correct plane location (X′, Y′), and an error column (ΔX, ΔY). The preliminary plane location column (X, Y) can be obtained through the TOA, AOA or RSS techniques. The tilt angle may be determined by the image sensor 210, or by a motion sensor 308 of the mobile device 12 (FIG. 3) and then be sent back to the positioning device 10. The preliminary plane location column (X, Y) can be estimated by the positioning circuit 206. Later, the controller 200 may correct the error (ΔX, ΔY) in the preliminary plane location column (X, Y) calculated by the positioning circuit 206 by utilizing the error-correction lookup table based on the tilt angle θ of the mobile device 12, thereby obtaining the correct plane position (X′, Y′). In terms of a mathematical expressions, (X′, Y′)=(X, Y)−(ΔX, ΔY), or (X′, Y′)=(X, Y)+(ΔX, ΔY).

TABLE 1

| | (X′, Y′) | θ | (X, Y) | (ΔX, ΔY) |
|---|---|---|---|---|
| XY-θ₁ | X1′, Y1′ | θ₁ | X1, Y1 | ΔX1, ΔY1 |
| XY-θ₂ | X2′, Y2′ | θ₂ | X2, Y2 | ΔX2, ΔY2 |
| XY-θ₃ | X3′, Y3′ | θ₃ | X3, Y3 | ΔX3, ΔY3 |

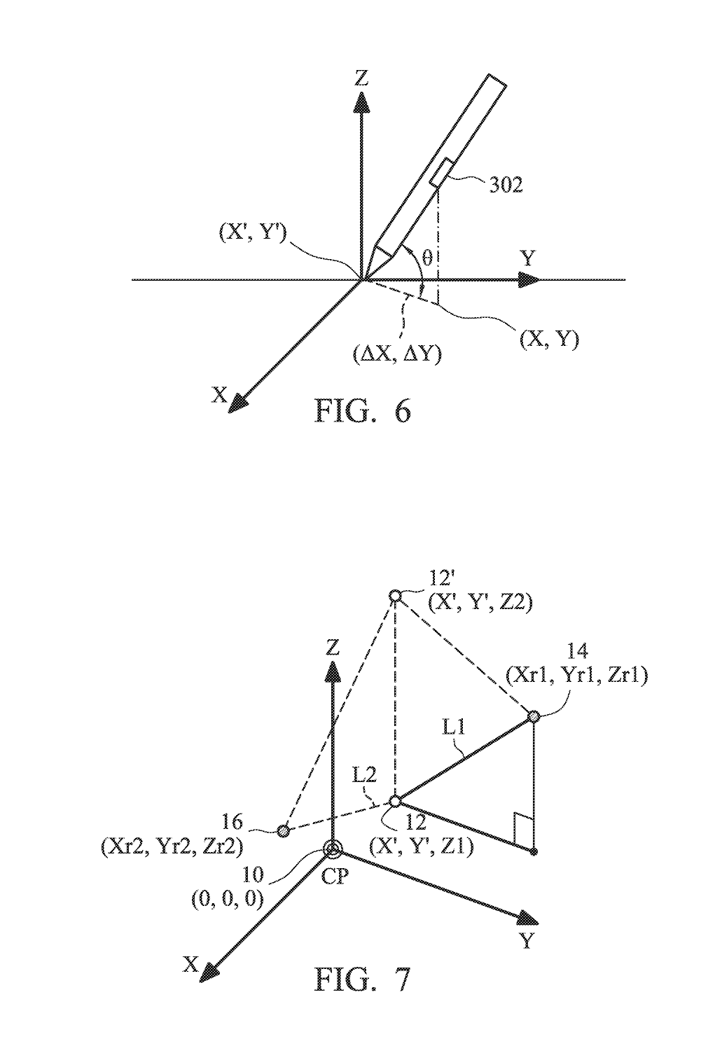

Referring to FIG. 6, illustrating the plane positioning error in the positioning method according to an embodiment of the invention, illustrating how the estimated error (ΔX, ΔY) is used to determine the correct plane location (X′, Y′). The mobile device 12 in FIG. 6 is a positioning pan device or a remote control, and the wireless transceiver thereof is posited at the middle section of the mobile device 12. The positioning device 10 is required to locate the position of the tip of the mobile device 12. When the mobile device 12 and a reference plane form a tilt angle θ, the positioning device 10 can locate the preliminary plane location as (X, Y), while the correct plane location to be found is (X′, Y′), and the error between the preliminary plane location (X, Y) and the correct plane location (X′, Y′) is (ΔX, ΔY).

Referring now back to the table 1, when positioning device 10 and the mobile device 12 are during manufacturing factory testing, the factory can establish several error-correction lookup tables corresponding to certain positioning environments. For any given positioning environment, the controller 200 may be configured to measure errors for each fixed distance from the controller 200 in the positioning range, thereby deriving an error-correction lookup table. For example, when establishing the lookup table, the error measurements for the mobile device 12 may be taken at the correct positioning locations (X′, Y′) at every circular range with 0.5 meter of the range differences and every 30 degrees of the angle differences centered by the positioning device 10, the positioning device 10 can take a measurement for the preliminary plane locations (X, Y) of the mobile device 12 at the predetermined locations for every 15 degrees of the tilt angles θ, thereby calculating the corresponding error (ΔX, ΔY) and establishing the error-correction lookup table. When installing the positioning system 1 for the first time, the controller 200 may load the error-correction lookup table to be used from among several error-correction lookup tables according to the corresponding positioning environment.

In some embodiments, the controller 200 of the positioning device 10 may compute a corresponding error (ΔX, ΔY) based on the tilt angle θ of the mobile device 12, thereby correcting the error in the preliminary plane location (X, Y) and obtaining the correct plane location (X′, Y′). For example, the wireless transceiver 204 may be 10 cm away from the position of the tip of the mobile device 12 that is to be estimated, and the controller 200 can estimate the corresponding error (ΔX, ΔY) based on mathematical trigonometry and the tilt angle θ, rendering the correct plane location (X′, Y′).

The image sensor 210 may be a still camera or a video camera, configured to detect the tilt angle of the mobile device 12. The indication device 212 may be a light-emitting diode (LED) device, an image-display device or an audio device, configured to indicate positioning status as the positioning process is underway or completed. The indication of indication device 212 may be indicated by the ON or OFF states or the blinking state of the LED device, or indicated by a display image, a picture or text of the image-display device, or indicated by an audio clip or another indication by the audio device informing the user of the current positioning status. The power-supply device 208 is configured to provide power to the positioning device 10 and is connected to an external power supply or a power storage device such as a battery.

The embodiment provides a positioning device capable of positioning a mobile device and correcting errors in the positioning data, correcting the positioning error in the plane positioning method and device.

FIG. 3 is a block diagram of the mobile device 12 according to an embodiment of the invention, including a controller 300, a wireless transceiver 302, a positioning circuit 304, a power-supply device 306, a motion sensor 308, and an indication device 310. The controller 300 is coupled to the wireless transceiver 302, the positioning circuit 304, the power-supply device 306, the motion sensor 308, and an indication device 310. In some embodiments, the mobile device 12 may not include the positioning circuit 304, the motion sensor 308, or the indication device 310, which are optional devices. The user can utilize the mobile device 12 to input data or commands to the positioning system 1.

The controller 300 is configured to determine information and requests from the user. Information from the user may include the priority of using the apparatus. The positioning circuit 302 may employ the TOA, AOA or RSS techniques which determine the preliminary location of the mobile device 12 with respect to the positioning device 10, determine the locations of the reference devices 14 and 16, and determine distances between the reference devices 14 and 16. The motion sensor 308 may be a gravity sensor or an accelerometer, configured to detect the tilt angle of the mobile device 12. The wireless transceiver 302 is configured to exchange information with the positioning device 10 and reference devices 14 and 16, and transmit the location information and the tilt angle of the mobile device 12 to the positioning device 10.

The indication device 310 may be an LED device, an image-display device, or an audio device, configured to indicate the positioning status as the positioning process is underway or completed. The indication device 310 may be indicated by the ON or OFF states or the blinking state of the LED device, or indicated by a display image, picture, or text on the image-display device, or indicated by an audio clip or another indication of the audio device, informing the user of the current positioning status. The power-supply device 306 is configured to provide power to the mobile device 12 and is connected to an external power supply or a power storage device such as a battery.

The embodiment provides a mobile device capable of inputting data or commands by traces in the predetermined spatial range.

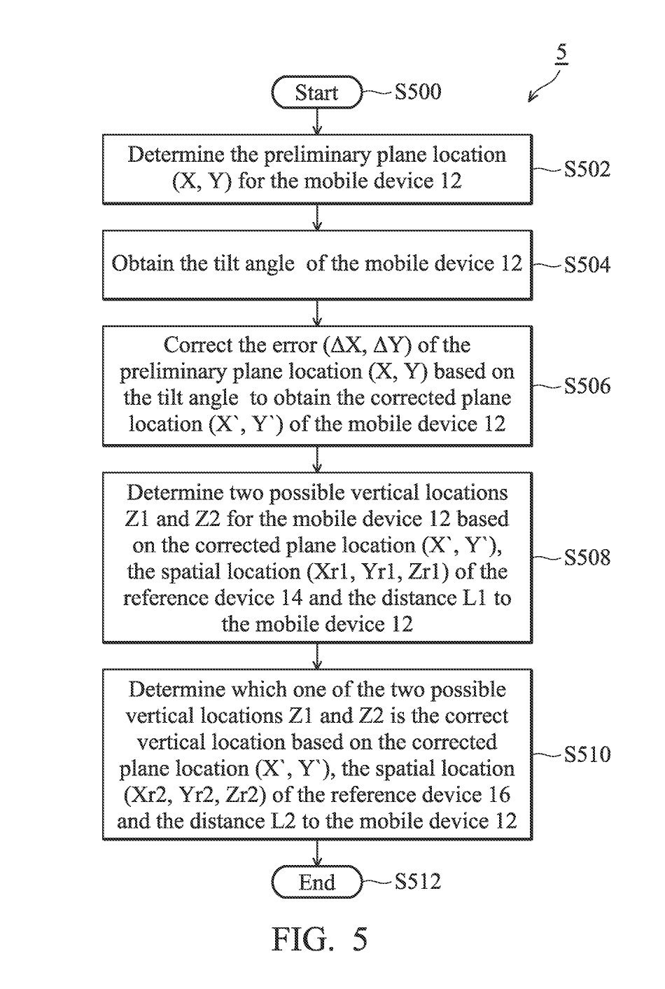

FIG. 4 is a block diagram of the reference devices 14 or 16 according to an embodiment of the invention, including a positioning circuit 400, a wireless transceiver 402 and a power-supply device 404. The positioning circuit 400 is coupled to the wireless transceiver 402 and the power-supply device 404. The reference devices 14 and 16 serve as reference points, configured to assist the mobile device 12 in the 3D-space positioning. The 3D positioning method is detailed in FIGS. 5 and 7.

The positioning circuit 400 may employ the TOA, AOA, or RSS techniques which determine the locations of the reference devices 14 and 16 and their distance from the mobile device 12. The wireless transceiver 402 is configured to exchange information with the positioning device 10 and the mobile device 12 and transmit the location information of the reference devices 14 and 16 and the distance information to the mobile device 12 to the positioning device 10. The power-supply device 404 is configured to provide power to the reference device 14 or 16 and is connected to an external power supply or a power storage device such as a battery.

The embodiment provides a reference device for assisting in the 3D positioning of the mobile device 12.

FIG. 5 is a flowchart of a 3D positioning method 5 according to an embodiment of the invention, incorporating the positioning system 1 in FIG. 1.

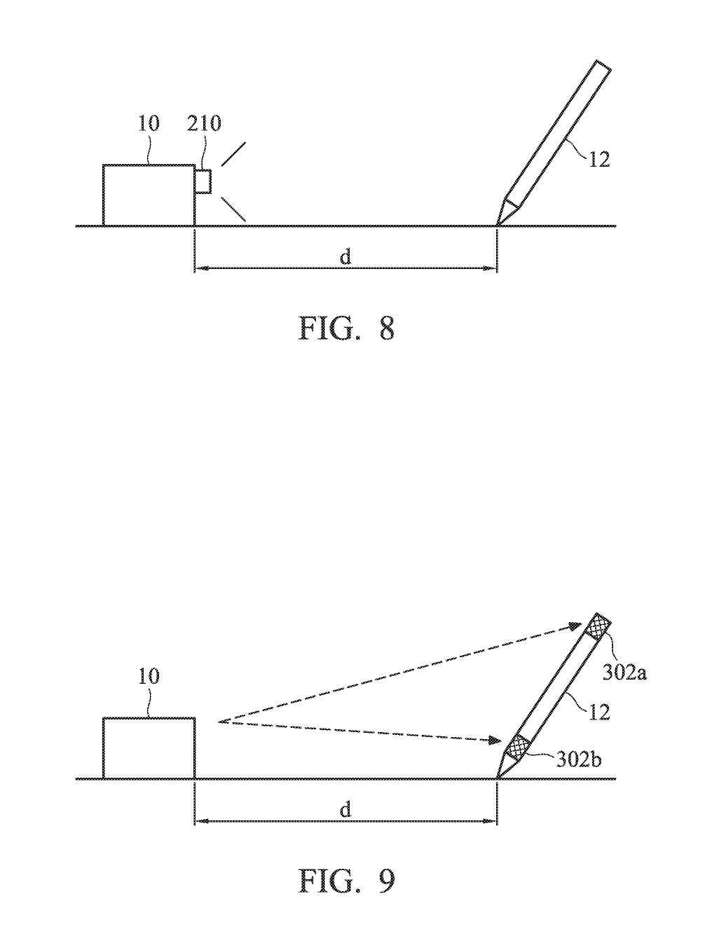

When the positioning method 5 starts, the positioning device 10 may select an error-correction lookup table for correcting the positioning error based on the positioning environment of the positioning system 1 (S500). The error-correction lookup table may be in the form as shown in table 1. The mobile device 12 may enter the selection for the error-correction lookup table. Next, the positioning system can determine the preliminary plane location (X, Y) of the mobile device 12 based on the TOA, AOA, RSS or another positioning technique (S502), obtain the tilt angle θ of the mobile device 12 (S504), and correct the error (ΔX, ΔY) in the preliminary plane location based on the tilt angle θ to obtain the correct plane location (X′, Y′) for the mobile device 12 (S506). In some embodiments, the positioning device 10 can utilize the image sensor of the still camera or the video camera to detect the image of the mobile device 12, then the controller 200 can determine the tilt angle θ of the mobile device 12 by analyzing the detected image data, as depicted in FIG. 8. In other embodiments, the positioning device 10 can broadcast the detection signal through the wireless transceiver 204, and receive two response signals reflected or transmitted from two different positions 302a and 302b on the mobile device 12. Since the two positions 302a and 302b are at different locations, the times for receiving the two response signals are different. The controller 200 can then determine the tilt angle θ of the mobile device 12 by processing the reception times for the two response signals, as shown in FIG. 9. In yet other embodiments, the mobile device 12 may determine the tilt angle θ thereof by the motion sensor 308, and return the tilt angle θ information to the positioning device 10. The positioning device 10 may find the corresponding error (ΔX, ΔY) from the selected error-correction lookup table based on the tilt angle θ. The positioning device 10 may also compute the corresponding error (ΔX, ΔY) based on the tilt angle θ. Furthermore, the positioning device 10 can remove the error (ΔX, ΔY) from the preliminary plane location (X, Y) to obtain the correct plane location (X′, Y′), thereby completing the plane positioning procedure for the mobile device 12.

The positioning device 10 can next locate the location of the mobile device 12 within a 3D space based on the locations of the first reference device 14 and the second reference device 16. Firstly, the positioning device 10 can obtain accurate spatial locations for the first reference device 14 and the second reference device 16 and their respective distance from the mobile device 12. In some embodiments, accurate spatial locations for the first reference device 14 and the second reference device 16 may be configured in advance. The respective distance of the first reference device 14 and the second reference device 16 to the mobile device 12 may be determined by the positioning circuit in the first reference device 14, the second reference device 16, or the mobile device 12 based on the TOA, AOA, RSS or another positioning technique. FIG. 7 shows a 3D positioning procedure according to an embodiment of the invention, including the 3D locations of the first reference device 14, the second reference device 16 and the mobile device 12. The positioning device 10 is located at an origin (0, 0, 0), the first reference device 14 is located at the coordinates (Xr1, Yr1, Zr1), the second reference device 16 is located at the coordinates (Xr2, Yr2, Zr2), and the mobile device 12 is located at the coordinates (X′, Y′, Z1). The first distance from the first reference device 14 to the mobile device 12 is L1, and the second distance from the second reference device 16 to the mobile device 12 is L2. By utilizing 3D trigonometry, the positioning device 10 can compute two possible vertical locations Z1 and Z2 for the mobile device 12 according to the correct plan location (X′, Y′) of the mobile device 12, the first distance L1 from the first reference device 14 to the mobile device 12, and the second distance L2 from the second reference device 16 to the mobile device 12, as expressed by the following:

(X′−Xr1)̂2+(Y′−Yr1)̂2+(Z−Zr1)̂2=L1̂2

Z=Zr1±(L1̂2−(X′−Xr1)̂2+(Y′−Yr1)̂2)̂0.5

The two possible vertical locations Z1 and Z2 have the same distance to the first reference device coordinates (Xr1, Yr1, Zr1) (S508). Referring to the embodiments in FIGS. 5 and 7, the positioning device 10 can compute by taking the two possible locations (X′, Y′, Z1) and (X′, Y′, Z2), the second distance L2 from the second reference device 16 to the mobile device 12 and the second reference device coordinates (Xr2, Yr2, Zr2) into the trigonometric relationship to determine which of the two possible vertical locations Z1 and Z2 is the correct vertical location (S510). The correct vertical location can conform to the trigonometric relationship with the second distance L2 and the second reference device coordinates (Xr2, Yr2, Zr2). In the embodiment disclosed in FIG. 7, the correct spatial location for the mobile device 12 is at coordinates (X′, Y′, Z1). Accordingly, the distance from the coordinates (X′, Y′, Z1) of the mobile device 12 to the second reference device coordinates (Xr2, Yr2, Zr2) is the second distance L2, while the distance from the other possible coordinates (X′, Y′, Z2) to the second reference device coordinates (Xr2, Yr2, Zr2) will not be the second distance L2. In order to determine the vertical location of the mobile device 12, the vertical locations of the first reference device 14 and the second reference device 16 cannot be identical. In Step S512, the positioning method 5 is completed and exited.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine.

The operations and functions of the various logical blocks, modules, and circuits described herein may be implemented in circuit hardware or embedded software codes that can be accessed and executed by a processor.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the invention shall be defined and protected by the following claims and their equivalents.

What is claimed is:

1. A positioning method, adopted by an electronic device for positioning a mobile device, comprising:
determining a preliminary plane location of the mobile device;
obtaining a tilt angle of the mobile device;
correcting an error in the preliminary plane location based on the tilt angle, to obtain a correct plane location of the mobile device;
obtaining a first distance between the mobile device and a first reference device, and a first spatial location of the first reference device;
obtaining a second distance between the mobile device and a second reference device, and a second spatial location of the second reference device;
determining two possible vertical locations for the mobile device according to the correct plane location, the first distance, and the first spatial location; and
determining one of the two possible vertical locations as a correct vertical location for the mobile device according to the correct plane location, the second distance, and the second spatial location;
wherein the first reference device and second reference device have different vertical locations.

2. The positioning method of claim 1, wherein the step of correcting the preliminary plane location comprises looking up the tilt angle in a lookup table to obtain the error in the preliminary plane location.

3. The positioning method of claim 1, wherein the step of obtaining the tilt angle comprises:
obtaining, by an image sensor on the electronic device, an image of the mobile device; and
determining the tilt angle of the mobile device by processing the image of the mobile device.

4. The positioning method of claim 1, wherein the step of obtaining the tilt angle comprises obtaining the tilt angle by receiving a signal transmitted by the mobile device.

5. The positioning method of claim 1, wherein the step of determining the preliminary plane location may be implemented by a Time of Arrival technique, an Angle of Arrival, or a Received Signal Strength technique.

6. An electronic device, comprising:
a transceiver, configured to receive a first signal from a mobile device;
a controller, coupled to the transceiver, configured to determine a preliminary plane location of the mobile device according to the received first signal, obtain a tilt angle of the mobile device, correct an error in the preliminary plane location based on the tilt angle to obtain a correct plane location of the mobile device; obtain a first distance between the mobile device and a first reference device, and a first spatial location of the first reference device; obtain a second distance between the mobile device and a second reference device, and a second spatial location of the second reference device; determine two possible vertical locations for the mobile device according to the correct plane location, the first distance, and the first spatial location; and determine one of the two possible vertical locations as the correct vertical location for the mobile device according to the correct plane location, the second distance, and the second spatial location;
wherein the first reference device and second reference device have different vertical locations.

7. The electronic device of claim 6, wherein the controller is configured to look up the tilt angle in a lookup table to obtain the error in the preliminary plane location.

8. The electronic device of claim 6, further comprising an image sensor, coupled to the controller, configured to obtain an image of the mobile device;
wherein the controller is configured to determine the tilt angle of the mobile device by processing the image of the mobile device.

9. The electronic device of claim 6, wherein the controller is configured to obtain the tilt angle by receiving a signal transmitted by the mobile device.

10. The electronic device of claim 6, wherein the controller is configured to determine the preliminary plane location using a Time of Arrival technique, an Angle of Arrival technique, or a Received Signal Strength technique.
